(19) United States
(12) Patent Application Publication
(10) Pub. No.: US 2023/0391042 A1
(43) Pub. Date: Dec. 7, 2023

(54) FIBER REINFORCED SANDWICH COMPOSITE PANELS AND METHODS OF MAKING

(71) Applicant: Technology Innovation Institute – Sole Proprietorship LLC, Masdar City (AE)

(72) Inventors: Zhongwei Guan, Masdar City (AE); Mohamed Nasr Saleh, Masdar City (AE); Changze Sun, Masdar City (AE); Hamda Albustani, Masdar City (AE)

(73) Assignee: Technology Innovation Institute – Sole Proprietorship LLC, Masdar City (AE)

(21) Appl. No.: 18/322,886

(22) Filed: May 24, 2023

Related U.S. Application Data
(60) Provisional application No. 63/365,751, filed on Jun. 2, 2022.

(51) Int. Cl. B32B 3/26; B32B 7/09; B32B 7/02; B32B 3/12; B32B 3/20

(52) U.S. Cl. CPC B32B 3/266; B32B 7/09; B32B 7/02; B32B 3/12; B32B 3/20; B32B 2307/7376; B32B 2260/023; B32B 2260/046; B32B 2262/106; B32B 5/26

(57) ABSTRACT

Fiber reinforced sandwich composite panels and methods for manufacturing are described. The fiber reinforced sandwich composite panels comprise a top layer, a bottom layer, a core layer, a continuous reinforcing yarn passing through the panel at a plurality of apertures and a continuous weft yarn interlocked with the reinforcing yarn.

### CROSS-REFERENCE TO RELATED APPLICATIONS

This application claims priority to U.S. Provisional Application Ser. No. 63/365,751, filed on Jun. 2, 2022, the entirety of which is incorporated by reference herein.

### BACKGROUND

Sandwich composite panels are commonly used in various automotive, marine, robotics, and aerospace applications. The panels are favored because of their high strength and stiffness with lower weight in comparison to solid materials. The outer layers of the panels provide support for in-plane loads, and opposite layers react in compression and tension to support the panel. The inner layer provides support for out-of-plane loads and for shear loads. Reinforcing fibers can be included in the core layer in applications where higher strength and higher stiffness is required. The inner layer is often attached to each of the outer layers using an adhesive layer. However, sandwich composite panels often experience delamination and debonding of the adhesive layer. The reinforcing fibers present in the core layer of the panel do not provide any advantages in the prevention of delamination as they do not integrate the inner layer with the outer layers.

### SUMMARY

Aspects, features, benefits and advantages of the embodiments described herein will be apparent with regard to the following description, appended claims, and accompanying drawings where:

In some embodiments, the techniques described herein relate to a fiber reinforced sandwich composite panel including: a sandwich composite panel including; a top layer; a bottom layer; a core layer positioned between the top layer and the bottom layer; and, a plurality of apertures, wherein each of the plurality of apertures pass through each layer of the composite panel; and a continuous reinforcing yarn, wherein, the reinforcing yarn passes through each of the plurality of apertures; wherein, the fiber reinforced sandwich composite panel has a thickness greater than about 30 mm, and the volume fraction of the continuous reinforcing yarn in each of the plurality of apertures is greater than about 50%.

In some embodiments, the techniques described herein relate to a fiber reinforced sandwich composite panel, the volume fraction of the continuous reinforcing yarn in each of the plurality of apertures about 55%, about 60%, about 65%, about 70%, or any value or range between any two of these values.

In some embodiments, the techniques described herein relate to a fiber reinforced sandwich composite panel, wherein the fiber reinforced sandwich composite panel has a thickness of about 35 mm, about 40 mm, about 45 mm, about 50 mm, about 55 mm, about 60 mm, about 65 mm, about 70 mm, about 75 mm, about 80 mm, about 85 mm, about 90 mm, about 95 mm, about 100 mm, about 110 mm, about 120 mm, about 130 mm, about 140 mm, about 150 mm, about 160 mm, about 170 mm, about 180 mm, about 190 mm, about 200 mm, about 225 mm, about 250 mm, about 275 mm, about 300 mm, about 325 mm, about 350 mm, about 375 mm, about 400 mm, about 425 mm, about 450 mm, about 475 mm, about 500 mm, or any value or range between any two of these values.

In some embodiments, the techniques described herein relate to a fiber reinforced sandwich composite panel, wherein the top layer has a thickness of about 0.1 mm, about 0.2 mm, about 0.25 mm, about 0.3 mm, about 0.4 mm, about 0.5 mm, about 0.6 mm, about 0.7 mm, about 0.8 mm, about 0.9 mm, about 1 mm, about 2 mm, about 3 mm, 4 mm, about 5 mm, about 6 mm, about 7 mm, about 8 mm, about 9 mm, about 10 mm, about 12 mm, about 14 mm, about 16 mm, about 18 mm, about 20 mm, about 25 mm, about 30 mm, about 35 mm, about 40 mm, about 45 mm, about 50 mm, or any value or range between any two of these values.

In some embodiments, the techniques described herein relate to a fiber reinforced sandwich composite panel, wherein the top layer includes polystyrene, polypropylene, carbon fiber, Kevlar fiber, aluminum, fiberglass, polyurethane, polyvinyl chloride, PET, polyethylene, nylon, or combinations thereof.

In some embodiments, the techniques described herein relate to a fiber reinforced sandwich composite panel, wherein the bottom layer has a thickness of about 0.1 mm, about 0.2 mm, about 0.25 mm, about 0.3 mm, about 0.4 mm, about 0.5 mm, about 0.6 mm, about 0.7 mm, about 0.8 mm, about 0.9 mm, about 1 mm, about 2 mm, about 3 mm, 4 mm, about 5 mm, about 6 mm, about 7 mm, about 8 mm, about 9 mm, about 10 mm, about 12 mm, about 14 mm, about 16 mm, about 18 mm, about 20 mm, about 25 mm, about 30 mm, about 35 mm, about 40 mm, about 45 mm, about 50 mm, or any value or range between any two of these values.

In some embodiments, the techniques described herein relate to a fiber reinforced sandwich composite panel, wherein the bottom layer includes polystyrene, polypropylene, carbon fiber, Kevlar fiber, aluminum, fiberglass, polyurethane, polyvinyl chloride, PET, polyethylene, nylon, or combinations thereof.

In some embodiments, the techniques described herein relate to a fiber reinforced sandwich composite panel, wherein the core layer has a thickness of about 25 mm, about 30 mm, about 35 mm, about 45 mm, about 50 mm, about 55 mm, about 60 mm, about 65 mm, about 70 mm, about 75 mm, about 80 mm, about 85 mm, 90 mm, about 95 mm, about 100 mm, about 110 mm, about 120 mm, about 130 mm, about 140 mm, about 150 mm, about 160 mm, about 170 mm, about 180 mm, about 190 mm, about 200 mm, about 225 mm, about 250 mm, about 275 mm, about 300 mm, about 325 mm, about 350 mm, about 375 mm, about 400 mm, about 425 mm, about 450 mm, about 475 mm, about 500 mm, or any value or range between any two of these values.

In some embodiments, the techniques described herein relate to a fiber reinforced sandwich composite panel, wherein the core layer includes polystyrene, polyurethane, extruded polystyrene, polyisocyanurate, mineral wool, aluminum, polyvinyl chloride, fiberglass, polycarbonate, PET, polyethylene, carbon fiber, wood, or combinations thereof.

In some embodiments, the techniques described herein relate to a fiber reinforced sandwich composite panel, wherein the core layer has a structure, wherein the structure includes a foam, a honeycomb, a lattice, composite tubes, or combinations thereof.

In some embodiments, the techniques described herein relate to a fiber reinforced sandwich composite panel, wherein each of the plurality of apertures has a diameter of about 5 mm, about 4 mm, about 3 mm, about 2 mm, about 1 mm, about 0.9 mm, about 0.8 mm, about 0.7 mm, about 0.6 mm, about 0.5 mm, or any value or range between any two of these values.

In some embodiments, the techniques described herein relate to a fiber reinforced sandwich composite panel, wherein the plurality of apertures is positioned in a periodic arrangement.

In some embodiments, the techniques described herein relate to a fiber reinforced sandwich composite panel, wherein the plurality of apertures is positioned in a sporadic arrangement.

In some embodiments, the techniques described herein relate to a fiber reinforced sandwich composite panel, wherein the fiber reinforced sandwich composite panel includes a concentration of apertures, wherein the concentration of apertures is 0.1 apertures/cm², 0.2 apertures/cm², 0.3 apertures/cm², 0.4 apertures/cm², 0.5 apertures/cm², 0.6 apertures/cm², 0.7 apertures/cm², 0.8 apertures/cm², 0.9 apertures/cm², 1 aperture/cm², 2 apertures/cm², 3 apertures/cm², 4 apertures/cm², 5 apertures/cm², or any value or range between any two of these values.

In some embodiments, the techniques described herein relate to a fiber reinforced sandwich composite panel, wherein the continuous reinforcing yarn includes carbon fiber, glass fiber, Kevlar fiber, aramid fiber, polyester fiber, natural fibers, ultra-high molecular weight polyethylene fiber, or combinations thereof.

In some embodiments, the techniques described herein relate to a fiber reinforced sandwich composite panel, wherein the continuous reinforcing fiber has a tow value, wherein the tow value of the continuous reinforcing yarn is about 1K, about 2K, about 3K, about 4K, about 5K, about 6K, about 8K, about 10K, about 12K, about 15K, about 18K, about 21K, about 24K, about 28K, about 30K, about 32K, about 36K, about 40K, about 44K, about 48K, about 50K, or any value or range between any two of these values.

In some embodiments, the techniques described herein relate to a fiber reinforced sandwich composite panel, wherein the continuous reinforcing yarn includes a plurality of stitches.

In some embodiments, the techniques described herein relate to a fiber reinforced sandwich composite panel further including a continuous weft yarn.

In some embodiments, the techniques described herein relate to a fiber reinforced sandwich composite panel, wherein the continuous weft yarn is interlocked with the continuous reinforcing yarn at each of the plurality of stitches.

In some embodiments, the techniques described herein relate to a fiber reinforced sandwich composite panel, wherein the continuous weft yarn includes carbon fiber, glass fiber, Kevlar fiber, aramid fiber, ultra-high molecular weight polyethylene fiber, or combinations thereof.

In some embodiments, the techniques described herein relate to a fiber reinforced sandwich composite panel further including a resin, wherein the resin is configured to transfer forces to the continuous reinforcing yarn.

In some embodiments, the techniques described herein relate to a fiber reinforced sandwich composite panel, wherein the resin includes a thermoset.

In some embodiments, the techniques described herein relate to a fiber reinforced sandwich composite panel, wherein the resin includes a thermoplastic.

In some embodiments, the techniques described herein relate to a fiber reinforced sandwich composite panel, wherein the resin includes polyester, epoxy, vinyl ester, phenolic, polyurethane, ABS, polyethylene, polystyrene, polycarbonate, acrylic based resin, or combinations thereof.

In some embodiments, the techniques described herein relate to a method of manufacturing a fiber reinforced sandwich composite panel including: providing a composite panel having a thickness greater than about 30 mm including; a top layer; a bottom layer; a core layer positioned between the top layer and the bottom layer; and, a plurality of apertures, wherein each of the plurality of apertures passes through the core layer; providing a continuous reinforcing yarn; providing a continuous weft yarn; creating a stitch at each of the plurality of apertures by threading the continuous reinforcing yarn through the top layer, one of the plurality of apertures, and the bottom layer; and interlocking the continuous weft yarn with the continuous reinforcing yarn at each stitch.

In some embodiments, the techniques described herein relate to a method, wherein each of the plurality of apertures passes through the top layer and the bottom layer.

In some embodiments, the techniques described herein relate to a method, wherein the creating of each stitch includes creating a stitch at one of the plurality of apertures adjacent to the previous stitch.

In some embodiments, the techniques described herein relate to a method, further including providing a resin and infusing the resin into the fiber reinforced sandwich composite panel.

In some embodiments, the techniques described herein relate to a method, further including infusing the resin by one of vacuum infusion, resin transfer molding, reaction injection molding, vacuum-assisted resin transfer molding, resin film infusion, or prepreg technology.

In some embodiments, the techniques described herein relate to a method, further including degassing the resin.

In some embodiments, the techniques described herein relate to a method, further including curing the fiber reinforced sandwich composite panel.

In some embodiments, the techniques described herein relate to a method, wherein the fiber reinforced sandwich composite panel is cured at a temperature of about 20° C., about 25° C., about 30° C., about 35° C., about 40° C., about 45° C., about 50° C., about 55° C., about 60° C., about 65° C., about 70° C., about 75° C., about 80° C., or any value or range between any two of these values.

### DESCRIPTION OF DRAWINGS

Aspects, features, benefits and advantages of the embodiments described herein will be apparent with regard to the following description, appended claims, and accompanying drawings where:

FIG. 1 illustrates a diagram of a cross section of a fiber reinforced sandwich composite panel in accordance with embodiments of the present disclosure.

FIG. 2 illustrates a diagram of a cross section of a fiber reinforced sandwich composite panel in accordance with embodiments of the present disclosure.

FIG. 3 illustrates a diagram of a cross section of a fiber reinforced sandwich composite panel in accordance with embodiments of the present disclosure.

FIG. 4 illustrates a diagram of the top surface of a fiber reinforced sandwich composite panel in accordance with embodiments of the present disclosure.

FIG. 5 illustrates a flow diagram for a method of manufacturing a fiber reinforced sandwich composite panel in accordance with embodiments of the present disclosure.

FIGS. 6A-6D illustrate a diagram of a method of manufacturing a fiber reinforced sandwich composite panel in accordance with embodiments of the present disclosure.

FIGS. 7A-7C illustrate a diagram of a reconstruction of a fiber reinforced sandwich composite panel in accordance with embodiments of the present disclosure.

FIG. 8 illustrates a graph of representative results of flatwise compression testing of fiber reinforced sandwich composite panels in accordance with embodiments of the present disclosure.

FIG. 9 illustrates a diagram of a surface of fiber reinforced composite panels during flatwise compression testing in accordance with embodiments of the present disclosure.

FIG. 10 illustrates a graph of representative results of edgewise compression testing of fiber reinforced sandwich composite panels in accordance with embodiments of the present disclosure.

FIG. 11 illustrates a diagram of a surface of fiber reinforced composite panels before edgewise compression testing in accordance with embodiments of the present disclosure.

FIG. 12 illustrates a diagram of a surface of fiber reinforced composite panels during edgewise compression testing in accordance with embodiments of the present disclosure.

### DETAILED DESCRIPTION

Embodiments are directed towards a fiber reinforced sandwich composite panel including a top layer, a bottom layer, a core layer positioned between the top layer and the bottom layer, a plurality of apertures passing through each of the layers, a continuous reinforcing yarn, and a continuous weft yarn. The continuous reinforcing yarn passes through each of the plurality of apertures and is present in each aperture in a volume fraction greater than 50 wt. %. The continuous reinforcing yarn and continuous weft yarn significantly improves the delamination resistance of the panel while providing an increase in out-of-plane stiffness and out-of-plane strength. The thickness of the fiber reinforced sandwich composite panel greater than about 30 mm also increases the out-of-plane stiffness and out-of-plane strength of the out-of-plane stiffness and out-of-plane strength without a significant increase in the weight.

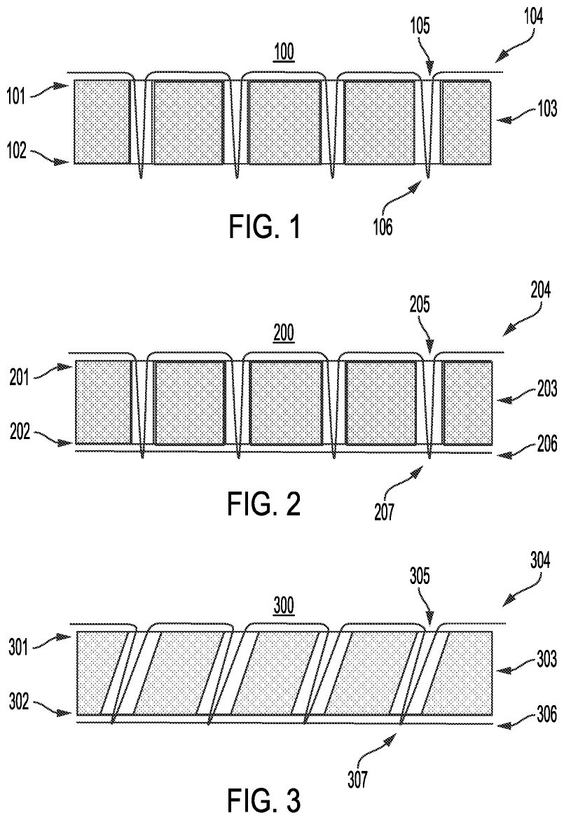

FIG. 1 illustrates a diagram of a cross section of a fiber reinforced sandwich composite panel 100 in accordance with embodiments of the present disclosure. The fiber reinforced sandwich composite panel 100 can include a top layer 101, a bottom layer 102, and a core layer 103 positioned between the top layer 101 and bottom layer 102. The fiber reinforced sandwich composite panel 100 can further include a plurality of apertures 105 that pass through each of the top layer 101, bottom layer 102 and core layer 103 at an angle perpendicular to the top layer 101. The fiber reinforced sandwich composite panel 100 includes a continuous reinforcing yarn 104, wherein the continuous reinforcing yarn 104 can be configured to pass through each of the plurality of apertures 105. The continuous reinforcing yarn 104 can be configured to provide a plurality of stitches 106, wherein each of the plurality of stitches 106 is positioned at the bottom of each of the plurality of apertures 105.

The fiber reinforced sandwich composite panel 100 has a thickness of greater than about 30 mm. The thickness of the fiber reinforced sandwich composite panel 100 can be about 35 mm, about 40 mm, about 45 mm, about 50 mm, about 55 mm, about 60 mm, about 65 mm, about 70 mm, about 75 mm, about 80 mm, about 85 mm, about 90 mm, about 95 mm, about 100 mm, about 110 mm, about 120 mm, about 130 mm, about 140 mm, about 150 mm, about 160 mm, about 170 mm, about 180 mm, about 190 mm, about 200 mm, about 225 mm, about 250 mm, about 275 mm, about 300 mm, about 325 mm, about 350 mm, about 375 mm, about 400 mm, about 425 mm, about 450 mm, about 475 mm, about 500 mm, or any value or range between any two of these values.

The top layer 101 is configured to provide support against in-plane forces and lateral bending forces. The top layer 101 may include any material effective to provide support against in-plane forces and lateral bending forces known to one of ordinary skill in the art. In some embodiments, the top layer 101 can include one or more of polystyrene, polypropylene, carbon fiber, Kevlar fiber, aluminum, fiberglass, polyurethane, polyvinyl chloride, PET, polyethylene, nylon, or combinations thereof.

In some embodiments, the top layer 101 can include a woven fabric. Each strand of the woven fabric can have a width of about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 2 mm, about 3 mm, 4 mm, about 5 mm, about 6 mm, about 7 mm, about 8 mm, about 9 mm, about 10 mm, or any value or range between any two of these values. In some embodiments, the woven fabric can have a tow value of about 1K, about 2K, about 3K, about 4K, about 5K, about 6K, about 8K, about 10K, about 12K, about 15K, about 18K, about 21K, about 24K, about 28K, about 30K, about 32K, about 36K, about 40K, about 44K, about 48K, about 50K, or any value or range between any two of these values.

The thickness of the top layer 101 can be about 0.1 mm, about 0.2 mm, about 0.25 mm, about 0.3 mm, about 0.4 mm, about 0.5 mm, about 0.6 mm, about 0.7 mm, about 0.8 mm, about 0.9 mm, about 1 mm, about 2 mm, about 3 mm, 4 mm, about 5 mm, about 6 mm, about 7 mm, about 8 mm, about 9 mm, about 10 mm, about 12 mm, about 14 mm, about 16 mm, about 18 mm, about 20 mm, about 25 mm, about 30 mm, about 35 mm, about 40 mm, about 45 mm, about 50 mm, or any value or range between any two of these values.

The bottom layer 102 is configured to provide support against in-plane forces and lateral bending forces. The bottom layer 102 may include any material effective to provide support against in-plane forces and lateral bending forces known to one of ordinary skill in the art. In some embodiments, the bottom layer 102 can include one or more of polystyrene, polypropylene, carbon fiber, Kevlar fiber, aluminum, fiberglass, polyurethane, polyvinyl chloride, PET, polyethylene, nylon, or combinations thereof.

In some embodiments, the bottom layer 102 can include a woven fabric. Each strand of the woven fabric can have a width of about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 2 mm, about 3 mm, 4 mm, about 5 mm, about 6 mm, about 7 mm, about 8 mm, about 9 mm, about 10 mm, or any value or range between any two of these values. In some embodiments, the woven fabric can have a tow value about 1K, about 2K, about 3K, about 4K, about 5K, about 6K, about 8K, about 10K, about 12K, about 15K, about 18K, about 21K, about 24K, about 28K, about 30K, about 32K, about 36K, about 40K, about 44K, about 48K, about 50K, or any value or range between any two of these values.

The thickness of the bottom layer 102 can be about 0.1 mm, about 0.2 mm, 0.25 mm, about 0.3 mm, about 0.4 mm, about 0.5 mm, about 0.6 mm, about 0.7 mm, about 0.8 mm, about 0.9 mm, about 1 mm, about 2 mm, about 3 mm, 4 mm, about 5 mm, about 6 mm, about 7 mm, about 8 mm, about 9 mm, about 10 mm, about 12 mm, about 14 mm, about 16 mm, about 18 mm, about 20 mm, about 25 mm, about 30 mm, about 35 mm, about 40 mm, about 45 mm, about 50 mm, or any value or range between any two of these values.

The core layer 103 is configured to provide support against out-of-plane forces, including out-of-plane shear forces. The core layer 103 may include any material effective to provide support against out-of-plane forces known to one of ordinary skill in the art. In some embodiments, the core layer 103 can include one or more of polystyrene, polyurethane, extruded polystyrene, polyisocyanurate, mineral wool, aluminum, polyvinyl chloride, fiberglass, polycarbonate, PET, polyethylene, carbon fiber, wood, or combinations thereof. The thickness of the core layer 103 can be about 25 mm, about 30 mm, about 35 mm, about 45 mm, about 50 mm, about 55 mm, about 60 mm, about 65 mm, about 70 mm, about 75 mm, about 80 mm, about 85 mm, 90 mm, about 95 mm, about 100 mm, about 110 mm, about 120 mm, about 130 mm, about 140 mm, about 150 mm, about 160 mm, about 170 mm, about 180 mm, about 190 mm, about 200 mm, about 225 mm, about 250 mm, about 275 mm, about 300 mm, about 325 mm, about 350 mm, about 375 mm, about 400 mm, about 425 mm, about 450 mm, about 475 mm, about 500 mm, or any value or range between any two of these values.

The structure of the core layer 103 may be controlled to control various properties of the fiber reinforced sandwich composite panel 100. The structure of the core layer 103 may include any core structure known to one of ordinary skill in the art. In some embodiments, the structure of the core layer 103 can include a foam, a honeycomb, a lattice, composite tubes, or combinations thereof. In some embodiments, the lattice pattern can be any lattice pattern known to one of skill in the art.

The continuous reinforcing yarn 104 is configured to provide support for the fiber reinforced sandwich composite panel 100 by improving the out-of-plane stiffness, the out-of-plane strength, and limiting debonding between the core layer and the top layer and the core layer and the bottom layer. The continuous reinforcing yarn 104 may include any material effective to provide support against out-of-plane forces known to one of ordinary skill in the art. In some embodiments, the continuous reinforcing yarn 104 can include one of carbon fiber, glass fiber, Kevlar fiber, aramid fiber, polyester fiber, natural fibers, ultra-high molecular weight polyethylene fiber, or combinations thereof. In some embodiments, the continuous reinforcing yarn 104 can have a tow value of about 1K, about 2K, about 3K, about 4K, about 5K, about 6K, about 8K, about 10K, about 12K, about 15K, about 18K, about 21K, about 24K, about 28K, about 30K, about 32K, about 36K, about 40K, about 44K, about 48K, about 50K, or any value or range between any two of these values.

The continuous reinforcing yarn 104 is configured to pass through each of the plurality of apertures 105. In some embodiments, the continuous reinforcing yarn 104 is configured to create a plurality of stitches 106, wherein each of the plurality of stitches 106 is positioned at the bottom of each of the plurality of apertures 105. In some embodiments, the volume fraction of the continuous reinforcing yarn 104 in each of the plurality of apertures 105 is greater than about 50%. The volume fraction of the continuous reinforcing yarn 104 in each of the plurality of apertures 105 can be about 55%, about 60%, about 65%, about 70%, about 75%, about 80%, about 85%, about 90%, about 95%, or any value or range between any two of these values.

In some embodiments, the plurality of apertures 105 passes through each layer of the fiber reinforced sandwich composite panel 100. In some embodiments, the each of the plurality of apertures 105 has a diameter of about 5 mm, about 4 mm, about 3 mm, about 2 mm, about 1 mm, about 0.9 mm, about 0.8 mm, about 0.7 mm, about 0.6 mm, about 0.5 mm, about 0.4 mm, about 0.3 mm, about 0.2 mm, about 0.1 mm, or any value or range between any two of these values.

In some embodiments, each of the plurality of apertures 105 are positioned in a periodic arrangement in the reinforced sandwich composite panel. In some embodiments, each of the plurality of apertures 105 are positioned in a sporadic arrangement in the reinforced sandwich composite panel. The distance between any two of the plurality of apertures 105 can be about 1 mm, about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, 21 mm, about 22 mm, about 23 mm, about 24 mm, about 25 mm, about 26 mm, about 27 mm, about 28 mm, about 29 mm, about 30 mm, about 35 mm, about 40 mm, about 45 mm, about 50 mm, or any value or range between any two of these values.

The fiber reinforced sandwich composite panel 100 can generally include any concentration of the plurality of apertures 105. For example, the concentration of the plurality of apertures 105 can be 0.1 apertures/cm², 0.2 apertures/cm², 0.3 apertures/cm², 0.4 apertures/cm², 0.5 apertures/cm², 0.6 apertures/cm², 0.7 apertures/cm², 0.8 apertures/cm², 0.9 apertures/cm², 1 aperture/cm², 2 apertures/cm², 3 apertures/cm², 4 apertures/cm², 5 apertures/cm², or any value or range between any two of these values.

In some embodiments, each of the plurality of apertures 105 are configured at the same angle relative to the top layer. In some embodiments, each of the plurality of apertures 105 are perpendicular to the top layer. The angle of the plurality of apertures 105 relative to the top layer 101 can be about 5°, about 10°, about 15°, about 20°, about 25°, about 30°, about 35°, about 40°, about 45°, about 50°, about 55°, about 60°, about 65°, about 70°, about 75°, about 80°, about 85°, or any value or range between any two of these values.

FIG. 2 illustrates a diagram of a cross section of a fiber reinforced sandwich composite panel 200 in accordance with embodiments of the present disclosure. The fiber reinforced sandwich composite panel 200 is a similar fiber reinforced sandwich composite panel as described in FIG. 1. The fiber reinforced sandwich composite panel 200 can include a top layer 201, a bottom layer 202, and a core layer 203 positioned between the top layer 201 and bottom layer 202. The fiber reinforced sandwich composite panel 200 can further include a plurality of apertures 205 configured at an angle perpendicular to the top layer 201. The fiber reinforced sandwich composite panel 200 can include a continuous reinforcing yarn 204, a plurality of stitches 207, and a continuous weft yarn 206 configured to interlock with the continuous reinforcing yarn 204 at the plurality of stitches 207.

The continuous weft yarn 206 is configured to interlock with the continuous reinforcing yarn 204. In some embodiments the continuous weft yarn 206 is configured to interlock with the continuous reinforcing yarn 204 at each of the plurality of stitches 207. The continuous weft yarn 206 may include any material known to one of ordinary skill in the art. In some embodiments, the continuous weft yarn 206 can include one of carbon fiber, glass fiber, Kevlar fiber, aramid fiber, ultra-high molecular weight polyethylene fiber, or combinations thereof.

The continuous reinforcing yarn 204 and continuous weft yarn 206 are, in combination, configured to integrate the top layer 201 with the core layer 203 and to integrate the bottom layer 202 with the core layer 203. The integration of the top layer 201 with the core layer 203 and the bottom layer 202 with the core layer 203 provides significant improvements in preventing the delamination of the fiber reinforced sandwich composite panel 200.

FIG. 3 illustrates a diagram of a cross section of a fiber reinforced sandwich composite panel 300 in accordance with embodiments of the present disclosure. The fiber reinforced sandwich composite panel 300 is a similar fiber reinforced sandwich composite panel as described in FIG. 1. The fiber reinforced sandwich composite panel 300 can include a top layer 301, a bottom layer 302, and a core layer 303 positioned between the top layer 301 and bottom layer 302. The fiber reinforced sandwich composite panel 300 can further include a plurality of apertures 305 configured at an angle not perpendicular to the top layer 301. The fiber reinforced sandwich composite panel 300 can include a continuous reinforcing yarn 304, a plurality of stitches 307, and a continuous weft yarn 306 configured to interlock with the continuous reinforcing yarn 304 at the plurality of stitches 307.

In some embodiments, each of the plurality of apertures 305 are configured at the same angle relative to the top layer. The angle of the plurality of apertures 305 controls the angle of the continuous reinforcing yarn 304 through the fiber reinforced sandwich composite panel 300. The angle of the plurality of apertures 305 may be used to control the mechanical properties, including strength and stiffness, of the fiber reinforced sandwich composite panel 300 in different directions. The angle of the plurality of apertures 305 relative to the top layer 301 can be about 5°, about 10°, about 15°, about 20°, about 25°, about 30°, about 35°, about 40°, about 45°, about 50°, about 55°, about 60°, about 65°, about 70°, about 75°, about 80°, about 85°, or any value or range between any two of these values.

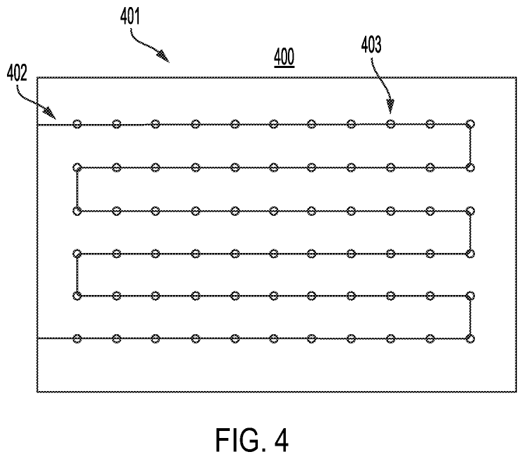

FIG. 4 illustrates a diagram of the top surface of a fiber reinforced sandwich composite panel 400 in accordance with embodiments of the present disclosure. The fiber reinforced sandwich composite panel 400 includes a top layer 401, a continuous reinforcing yarn 402, and a plurality of apertures 403. The continuous reinforcing yarn 402 passes through each of the apertures 403 and is configured along the top layer 401 between each of the plurality of apertures 403. This provides an integration between the top layer 401 and the core layer of the fiber reinforced sandwich composite panel 400.

The fiber reinforced sandwich composite panel 400 has a thickness of greater than about 30 mm. The thickness of the fiber reinforced sandwich composite panel 400 can be about 35 mm, about 40 mm, about 45 mm, about 50 mm, about 55 mm, about 60 mm, about 65 mm, about 70 mm, about 75 mm, about 80 mm, about 85 mm, about 90 mm, about 95 mm, about 100 mm, about 110 mm, about 120 mm, about 130 mm, about 140 mm, about 150 mm, about 160 mm, about 170 mm, about 180 mm, about 190 mm, about 200 mm, about 225 mm, about 250 mm, about 275 mm, about 300 mm, about 325 mm, about 350 mm, about 375 mm, about 400 mm, about 425 mm, about 450 mm, about 475 mm, about 500 mm, or any value or range between any two of these values.

The top layer 401 is configured to provide support against in-plane forces and lateral bending forces. The top layer 401 may include any material effective to provide support against in-plane forces and lateral bending forces known to one of ordinary skill in the art. In some embodiments, the top layer 401 can include one or more of polystyrene, polypropylene, carbon fiber, Kevlar fiber, aluminum, fiberglass, polyurethane, polyvinyl chloride, PET, polyethylene, nylon, or combinations thereof.

In some embodiments, the top layer 401 can include a woven fabric. Each strand of the woven fabric can have a width of about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 2 mm, about 3 mm, 4 mm, about 5 mm, about 6 mm, about 7 mm, about 8 mm, about 9 mm, about 10 mm, or any value or range between any two of these values. In some embodiments, the woven fabric can have a tow value of about 1K, about 2K, about 3K, about 4K, about 5K, about 6K, about 8K, about 10K, about 12K, about 15K, about 18K, about 21K, about 24K, about 28K, about 30K, about 32K, about 36K, about 40K, about 44K, about 48K, about 50K, or any value or range between any two of these values.

The thickness of the top layer 401 can be about 0.1 mm, about 0.2 mm, about 0.25 mm, about 0.3 mm, about 0.4 mm, about 0.5 mm, about 0.6 mm, about 0.7 mm, about 0.8 mm, about 0.9 mm, about 1 mm, about 2 mm, about 3 mm, 4 mm, about 5 mm, about 6 mm, about 7 mm, about 8 mm, about 9 mm, about 10 mm, about 12 mm, about 14 mm, about 16 mm, about 18 mm, about 20 mm, about 25 mm, about 30 mm, about 35 mm, about 40 mm, about 45 mm, about 50 mm, or any value or range between any two of these values.

The continuous reinforcing yarn 402 is configured to provide support for the fiber reinforced sandwich composite panel 400 by improving the out-of-plane stiffness, the out-of-plane strength, and limiting debonding between the core layer and the top layer and the core layer and the bottom layer. The continuous reinforcing yarn 402 may include any material effective to provide support against out-of-plane forces known to one of ordinary skill in the art. In some embodiments, the continuous reinforcing yarn 402 can include one of carbon fiber, glass fiber, Kevlar fiber, aramid fiber, polyester fiber, natural fibers, ultra-high molecular weight polyethylene fiber, or combinations thereof.

The continuous reinforcing yarn 402 is configured to pass through each of the plurality of apertures 403. The continuous reinforcing yarn 402 is configured to pass through adjacent apertures 403 in a consecutive order. The volume fraction of the continuous reinforcing yarn 402 in each of the plurality of apertures 403 is greater than about 50%. The volume fraction of the continuous reinforcing yarn 402 in each of the plurality of apertures 403 can be about 55%, about 60%, about 65%, about 70%, about 75%, about 80%, about 85%, about 90%, about 95%, or any value or range between any two of these values.

The plurality of apertures 403 passes through each layer of the fiber reinforced sandwich composite panel 400. In some embodiments, each of the plurality of apertures 403 has a diameter of about 5 mm, about 4 mm, about 3 mm, about 2 mm, about 1 mm, about 0.9 mm, about 0.8 mm, about 0.7 mm, about 0.6 mm, about 0.5 mm, about 0.4 mm, about 0.3 mm, about 0.2 mm, about 0.1 mm, or any value or range between any two of these values.

In some embodiments, each of the plurality of apertures 403 are positioned in a periodic arrangement in the reinforced sandwich composite panel. In some embodiments, each of the plurality of apertures 403 are positioned in a sporadic arrangement in the reinforced sandwich composite panel. The distance between any two of the plurality of apertures 403 can be about 1 mm, about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, 21 mm, about 22 mm, about 23 mm, about 24 mm, about 25 mm, about 26 mm, about 27 mm, about 28 mm, about 29 mm, about 30 mm, about 35 mm, about 40 mm, about 45 mm, about 50 mm, or any value or range between any two of these values.

The fiber reinforced sandwich composite panel 400 can generally include any concentration of the plurality of apertures 403. For example, the concentration of the plurality of apertures 403 can be 0.1 apertures/cm², 0.2 apertures/cm², 0.3 apertures/cm², 0.4 apertures/cm², 0.5 apertures/cm², 0.6 apertures/cm², 0.7 apertures/cm², 0.8 apertures/cm², 0.9 apertures/cm², 1 aperture/cm², 2 apertures/cm², 3 apertures/cm², 4 apertures/cm², 5 apertures/cm², or any value or range between any two of these values.

In some embodiments, each of the plurality of apertures 403 are configured at the same angle relative to the top layer. In some embodiments, each of the plurality of apertures 403 are perpendicular to the top layer. The angle of the plurality of apertures 403 relative to the top layer 401 can be about 5°, about 10°, about 15°, about 20°, about 25°, about 30°, about 35°, about 40°, about 45°, about 50°, about 55°, about 60°, about 65°, about 70°, about 75°, about 80°, about 85°, or any value or range between any two of these values.

In some embodiments, the fiber reinforced sandwich composite panel further includes a resin. In some embodiments, the resin is infused in the fiber reinforced sandwich composite panel in spaces in the core layer and in spaces in the apertures of the fiber reinforced sandwich composite panel. In some embodiments, the resin is configured to transfer forces to the continuous reinforcing yarn. In some embodiments, the resin is further configured to bind the continuous reinforcing yarn in place and protect the continuous reinforcing yarn from environmental damage.

The resin may include any material effective in transferring forces known to one of ordinary skill in the art. In some embodiments, the resin may include a thermoset. In some embodiments, the resin may include a thermoplastic. In some embodiments, the resin can include one of polyester, epoxy, vinyl ester, phenolic, polyurethane, ABS, polyethylene, polystyrene, polycarbonate, acrylic based resin, or combinations thereof.

Embodiments are directed towards a method of manufacturing a fiber reinforced sandwich composite panel including a top layer, a bottom layer, a core layer positioned between the top layer and the bottom layer, and a continuous reinforcing yarn.

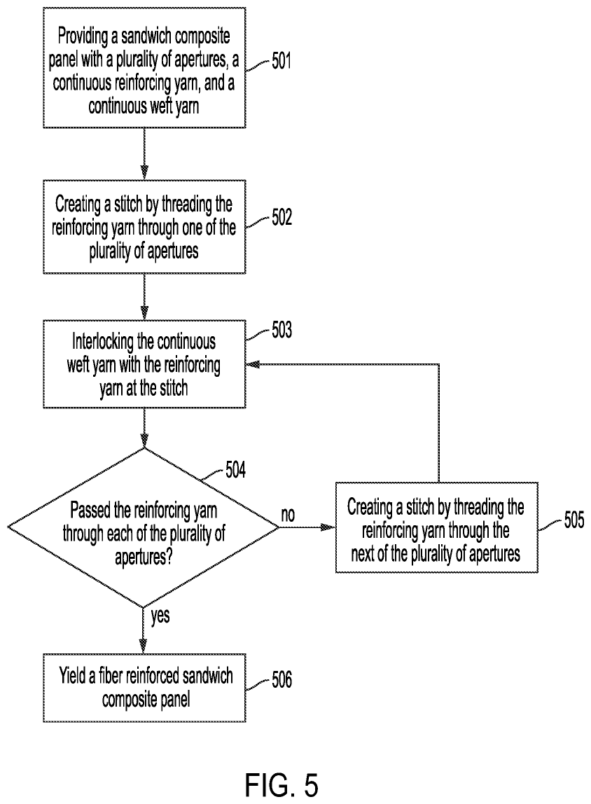

FIG. 5 illustrates a flow diagram for a method of manufacturing a fiber reinforced sandwich composite panel in accordance with embodiments of the present disclosure. The method includes the steps of providing 501 a sandwich composite panel with a plurality of apertures, a continuous reinforcing yarn, and a continuous weft yarn, creating 502 a stitch by threading the reinforcing yarn through one of the plurality of apertures, and interlocking 503 the continuous weft yarn with the reinforcing yarn at the stitch. The method includes a check step 504, where if the continuous reinforcing yarn has not passed through each of the plurality of apertures, then a stitch is created 505 by threading the reinforcing yarn through the next of the plurality of apertures. The continuous weft yarn is interlocked 503 with the stitch and the check 504 is repeated. If the continuous reinforcing yarn has passed through each of the plurality of apertures, then a fiber reinforced sandwich composite panel is yielded 506.

A sandwich composite panel having a thickness greater than about 30 mm and having a plurality of apertures, a continuous reinforcing yarn, and a continuous weft yarn are provided 501. In some embodiments, the sandwich composite panel can include a top layer, a bottom layer, and a core layer between the top layer and the bottom layer, and the plurality of apertures pass through each of the layers. In some embodiments, the fiber reinforced sandwich composite panel can include a top layer, a bottom layer, and a core layer between the top layer and the bottom layer, and the plurality of apertures pass through the core layer.

A stitch is then created 502 by threading the continuous reinforcing yarn through one of the plurality of apertures. In some embodiments, the continuous reinforcing yarn is threaded through the fiber reinforced sandwich composite panel starting from a top layer and is threaded through a bottom layer. In some embodiments, the continuous reinforcing yarn is threaded through the fiber reinforced sandwich composite panel using a threading device.

The continuous weft yarn is interlocked 503 with the continuous reinforcing yarn at the stitch. In some embodiments, the continuous weft yarn is interlocked 503 with the continuous reinforcing yarn by passing the continuous weft yarn through a loop in the stitch.

A check 504 is then performed where if the continuous reinforcing yarn has not passed through each of the plurality of apertures, then a stitch is created 505 using the continuous reinforcing yarn at the next of the plurality of apertures, wherein the next of the plurality of apertures is adjacent to the previous stitch. The continuous weft yarn is interlocked 503 with the continuous reinforcing yarn until the continuous reinforcing yarn is threaded through each of the plurality of apertures and the check 504 is repeated. If the continuous reinforcing yarn has passed through each of the plurality of apertures, then a fiber reinforced sandwich composite panel is yielded 506.

In some embodiments, a resin is provided and infused into the fiber reinforced sandwich composite panel. In some embodiments, the resin is infused into the fiber reinforced sandwich composite panel in spaces present in the core layer and the plurality of apertures. The resin can be infused by any infusion method known to one of skill in the art. In some embodiments, the resin is infused by one of vacuum infusion, resin transfer molding, reaction injection molding, vacuum-assisted resin transfer molding, resin film infusion, or prepreg technology.

In some embodiments, the method further includes a degassing the resin. In some embodiments, the degassing is performed to remove remaining air in the resin after the resin infusion. Air pockets can be areas of high stress within the fiber reinforced sandwich composite panel and cause failure.

In some embodiments, the method further includes curing the fiber reinforced sandwich composite panel. The curing can be performed at ambient temperature, at a temperature of about 20° C., about 25° C., about 30° C., about 35° C., about 40° C., about 45° C., about 50° C., about 55° C., about 60° C., about 65° C., about 70° C., about 75° C., about 80° C., or any value or range between any two of these values. In some embodiments, the curing includes a first curing at a first temperature and a second curing at a second temperature.

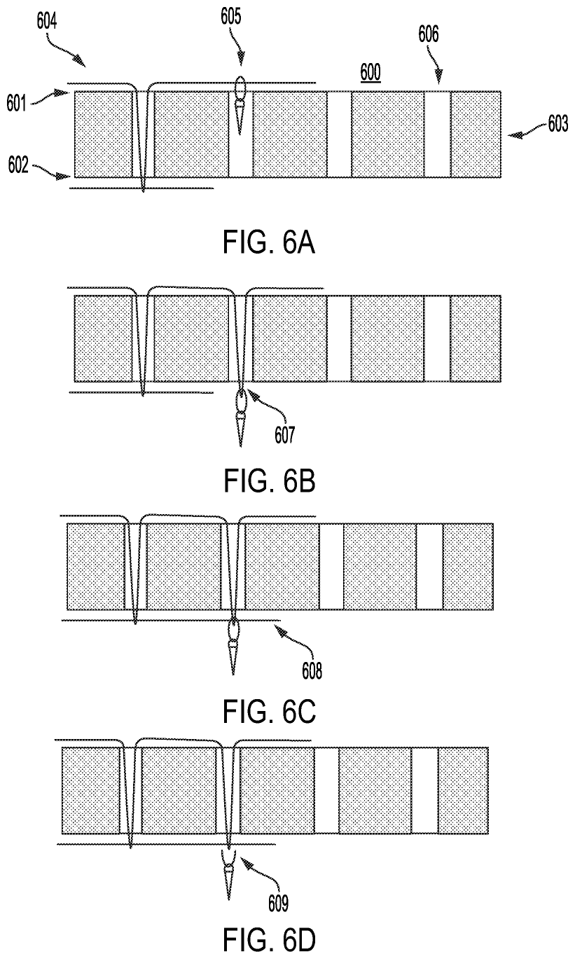

FIGS. 6A-6D illustrate a diagram of a method of manufacturing a fiber reinforced sandwich composite panel in accordance with embodiments of the present disclosure. The method can include providing a sandwich composite panel 600 including a top layer 601, a bottom layer 602, a core layer 603 positioned between the top layer 601 and the bottom layer 602, and a plurality of apertures 606. The method further comprises providing a continuous reinforcing yarn 604, a threading device 605, and a continuous weft yarn 608. The method includes threading the continuous reinforcing yarn 604 through one of the plurality of apertures 606 to create a stitch 607. The continuous weft yarn 608 is interlocked with the continuous reinforcing yarn 604 at the stitch 607 and the thread insertion device 605 is removed 609 from the continuous reinforcing yarn 604.

The top layer 601 can be provided as a woven fabric. The top layer 601 can be provided as a non-woven material. The top layer 601 be provided wherein the top layer 601 includes the plurality of apertures 606. The top layer 601 be provided wherein the top layer 601 does not include the plurality of apertures 606.

The bottom layer 602 can be provided as a woven fabric. The bottom layer 602 can be provided as a non-woven material. The bottom layer 602 be provided wherein the bottom layer 602 includes the plurality of apertures 606. The bottom layer 602 be provided wherein the bottom layer 602 does not include the plurality of apertures 606.

The core layer 603 can be provided including any core structure known to one of ordinary skill in the art. In some embodiments, the structure of the core layer 603 can include a foam, a honeycomb, a lattice, composite tubes, or combinations thereof. The core layer 603 is provided wherein the core layer 603 includes the plurality of apertures 606.

The continuous reinforcing yarn 604 can be provided as any material effective to be threaded through the plurality of apertures 606 and effective to provide support against out-of-plane forces. The continuous reinforcing yarn 604 can be provided as a single fiber or as a plurality of fibers.

The threading device 605 can be any threading device effective to thread the continuous reinforcing yarn 604 through the plurality of apertures 606. In some embodiments, the thread insertion device 605 is configured to puncture the top layer 601 and the bottom layer 602. In some embodiments, the thread insertion device 605 is a needle. In some embodiments, the thread insertion device 605 includes a first end configured to pass through the plurality of apertures 606 first and a second end configured to pass through the plurality of apertures 606 second. In some embodiments, the second end comprises a hole configured to attach the thread insertion device 605 to the continuous reinforcing yarn 604. The hole can be configured to move between an open position and a closed position, wherein the hole is moved to the open position to remove 609 the thread insertion device 605 from the continuous reinforcing yarn 604 and moved to the closed position to attach the thread insertion device 605 to the continuous reinforcing yarn 604.

In some embodiments, the plurality of apertures 606 passes through the core layer 603. In some embodiments, the plurality of apertures 606 pass through each of a top layer 601, a bottom layer 602, and a core layer 603. The plurality of apertures 606 can be provided at an angle relative to the top layer 601 of about 5°, about 10°, about 15°, about 20°, about 25°, about 30°, about 35°, about 40°, about 45°, about 50°, about 55°, about 60°, about 65°, about 70°, about 75°, about 80°, about 85°, about 90°, or any value or range between any two of these values.

The method includes attaching a thread insertion device 605 onto the continuous reinforcing yarn 604. The continuous reinforcing yarn 604 is then threaded through the sandwich composite panel 600. In some embodiments, the thread insertion device 605 is used to puncture the top layer 601 and the bottom layer 602 of the sandwich composite panel 600 to extend each of the plurality of apertures 606 to pass through each layer of the sandwich composite panel 600.

The thread insertion device 605 is passed completely through the sandwich composite panel 600 to create a stitch 607 with the continuous reinforcing yarn 604. A continuous weft yarn 608 is then interlocked with the continuous reinforcing yarn 604 at the stitch 607, and the thread insertion device is removed 609 from the continuous reinforcing yarn 604. The steps are repeated until the continuous weft yarn 608 is interlocked with the continuous reinforcing yarn 604 at a stitch 607 at each of the plurality of apertures 606.

### EXAMPLES

### Example 1

Carbon Fiber reinforced sandwich composite panels were produced by laying three plies of carbon fiber fabric with a density of 450 g/m², a tow value of 12 k, and a 2×2 twill, on each side of PVC80 foam with a thickness of 30 mm and a density of 80 kg/m³. The carbon fiber fabric was provided by Easy composites Ltd, UK, and the PVC foam was provided by Gurit. The PVC foam had apertures of 2 mm diameter with a spacing of 20×20 mm. A continuous carbon fiber yarn with a tow value of 12 k was stitched through the apertures to create sample FC-Y1. Samples were also made with a continuous carbon fiber yarn with a tow size of 24K to create sample FC-Y2. Sample FC-N was created without the use of a carbon fiber yarn. The carbon fiber yarns were provided by Grafil 34-700 Mitsubishi. The samples were then infused with a resin using Vacuum-Assisted Resin Infusion (VARI) technology. Epoxy resin Prime™27 and Prime™ slow hardener, both supplied by Gurit, were mixed with a weight ratio of 100:28, respectively to form the resin. A 10-minute degassing process was conducted in the 26L DS26-P professional degassing system from Easy composites Ltd with the help of a EC20 pump from Easy composites Ltd. The infused samples were cured at room temperature for 16 hours and post-cured in Precision Composites Curing Oven from Easy composites Ltd at 65° C. for 7 hours.

### X-Ray Computed Tomography—Example 1

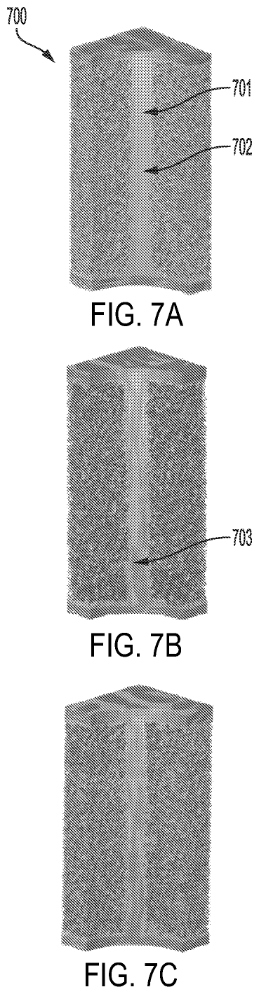

Fiber reinforced composite panels prepared in Example 1 were examined using X-ray Computed Tomography (CT). X-ray CT scans were performed on FC-N, FC-Y1, and FC-Y2 samples using a Phoenix nanotom m-machine. Scans were performed on samples with dimensions of 40 mm×40 mm×33 mm. Parameters included a 4× objective of the scanner, a source voltage of 120 kV, a current of 230 μA, and an exposure time for each radiograph of is with 2600 radiographs being collected over 360°. These parameters produced a voxel size of 25 μm. The scanned images were then used to create a 3D reconstruction of the samples using Avizo software. FIG. 7A illustrates a 3D reconstruction of a FC-N sample 700, FIG. 7B illustrates a 3D reconstruction of a FC-Y1 sample, and FIG. 7C illustrates a 3D reconstruction of a FC-Y2 sample. Each 3D reconstruction includes an aperture 701, wherein the aperture can include resin 702 and the carbon fiber yarn 703. The software was further used to calculate the volume of each material in the apertures. The calculations are illustrated in

TABLE 1

| Sample | Carbon Fiber Volume Percent (%) |
|---|---|
| FC-N | 0 |
| FC-Y1 | 34 |
| FC-Y2 | 55 |

### Flatwise Compression Testing—Example 1

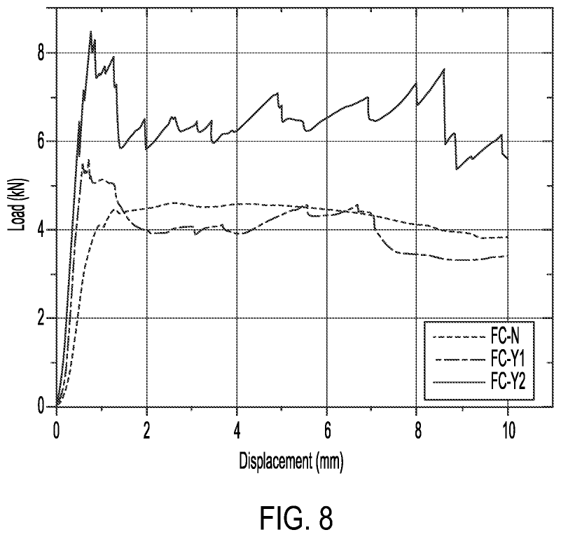

Fiber reinforced composite panels prepared in Example 1 were tested using flatwise compression testing. Five of each of the samples were prepared and testing was performed according to ASTM C297 standard. Testing was performed using an Instron 5982 machine with a 100 kN load cell capacity and a loading rate of 1 mm/min. Results are illustrated in TABLE 2 and in FIG. 8:

TABLE 2

| | Average | Ultimate Strength | Compressive |
|---|---|---|---|
| Sample | Ultimate Load (N) | (MPa) | Modulus (MPa) |
| FC-N | 4582 | 2.81 ± 0.04 | 114.6 ± 9.87 |
| FC-Y1 | 5892 | 3.62 ± 0.38 | 264.67 ± 9.45 |
| FC-Y2 | 7040 | 4.31 ± 0.48 | 301.61 ± 18.5 |

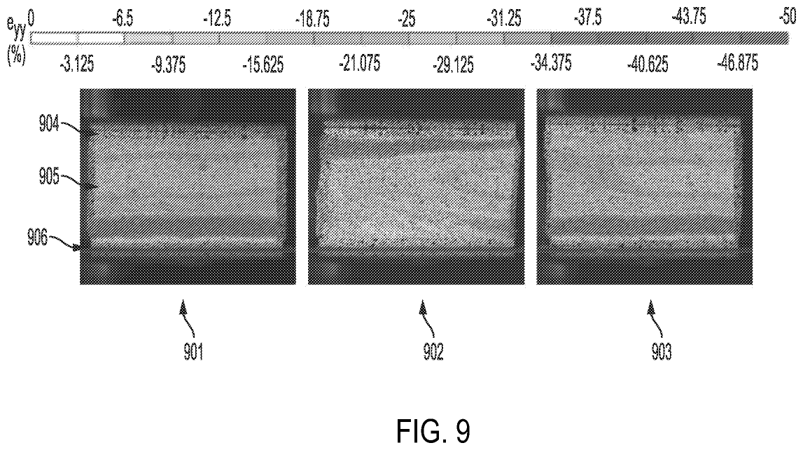

3D Digital Image Correlation (DIC) was performed on the surface of the samples continuously during the flatwise compression testing. DIC was performed using two Basler acA2440 cameras with a resolution of 5 MP and a XENOPLAN 1.9/35-0901 lens. The observation window was 40×30 mm² and the acquisition rate was 2 fps. FIG. 9 illustrates the images of the compression of FC-N 901, FC-Y1 902, and FC-Y2 903 samples after failure due to the flatwise compression testing. The images include the top layer 904, the core layer 905, and the bottom layer 906 of each of the samples. A surface strain map was calculated for each of the samples using the images and the compressive strain (eyy) after the flatwise compression testing was overlayed on the sample images.

### Edgewise Compression Testing—Example 1

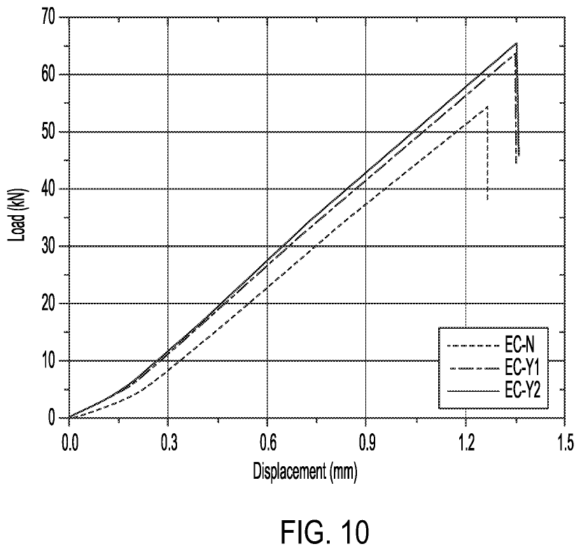

Fiber reinforced composite panels prepared in Example 1 were tested using edgewise compression testing. Samples with no continuous fiber reinforcement are referred to as EC-N, samples reinforced with a continuous carbon fiber yarn with a tow value of 12 k are referred to as EC-Y1, and samples reinforced with a continuous carbon fiber yarn with a tow value of 24K are referred to as EC-Y2. Five of each of the samples were prepared and testing was performed according to ASTM C364 standard. Testing was performed using an Instron 5982 machine with a 100 kN load cell capacity and a loading rate of 0.5 mm/min. Results are illustrated in TABLE 3 and in FIG. 10:

TABLE 3

| Sample | Average Ultimate Load (N) | Ultimate Strength (MPa) |
|---|---|---|
| EC-N | 5023 | 236.96 ± 2.29 |
| EC-Y1 | 6045 | 286.66 ± 1.62 |
| EC-Y2 | 5926 | 281.38 ± 1.58 |

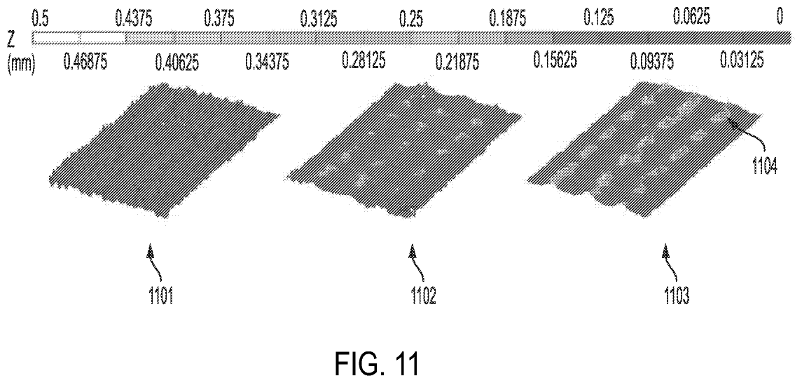

2D DIC was performed on the surface of the samples on images taken before the stitching was performed and after the manufacturing of the samples was completed and before the edgewise compression testing was performed. DIC was performed using a Photron Nova S16 camera with a Nikon AF-S VR Micro-Nikkor 105 mm f/2.8 G IF-ED lens. FIG. 11 illustrates the surface roughness of the top surface of the samples before the edgewise compression testing was performed. The top surface of EC-N 1101 had the lowest average surface roughness, while the top surface of EC-Y1 1102 and the top surface of EC-Y3 had areas of high irregularity. The areas of high irregularity in both EC-Y1 1102 and EC-Y2 1103 occurred around the position of the plurality of stitches 1104.

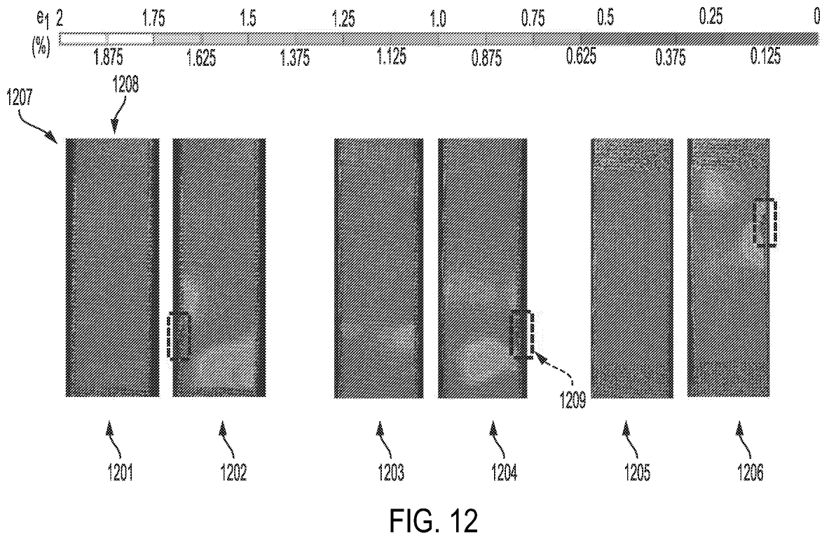

3D DIC was performed on the surface of the samples continuously during the edgewise compression testing. DIC was performed using two Basler acA2440 cameras with a resolution of 5 MP and a XENOPLAN 1.9/35-0901 lens. The observation window was 110×70 mm² and the acquisition rate was 2 fps. FIG. 12 illustrates the images of the compression of EC-N, EC-Y1, and EC-Y2 samples during edgewise compression testing prior to failure and after failure. The images include an image taken just prior to failure of sample EC-N 1201, an image taken after failure of EC-N 1202, an image taken just prior to failure of sample EC-Y1 1203, an image taken after failure of EC-Y1 1204, an image taken just prior to failure of sample EC-Y2 1205, and an image taken after failure of EC-Y2 1206. Each of the images include the carbon fiber fabric layers 1207 and the core layer 1208.

A surface strain map of principal strain was calculated for each of the samples using the images and the principal strain (e₁) was overlayed on the sample images. The images taken after failure 1202/1204/1206 include markers locating the position 1209 of failure of the samples. In each edgewise compression test, the failure mode resulted in a failure spanning across the entire width of the carbon fiber fabric layer where failure was experienced. In each of the EC-Y2 samples, the failure occurred at the stitches. In the EC-Y1 samples, failure occurred at the stitches or at a position between the stitches.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

It is to be understood that this invention is not limited to the particular processes, compositions, or methodologies described, as these may vary. It is also to be understood that the terminology used in the description is for the purpose of describing the particular versions or embodiments only and is not intended to limit the scope of the present invention, which will be limited only by the appended claims. Unless defined otherwise, all technical and scientific terms used herein have the same meaning as commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference in their entirety. Nothing herein is to be construed as an admission that the invention is not entitled to antedate such disclosure by virtue of prior invention.

It must also be noted that as used herein and in the appended claims, the singular forms “a,” “an,” and “the” include plural reference unless the context clearly dictates otherwise. Thus, for example, reference to “a sandwich composite panel” is a reference to “one or more sandwich composite panels” and equivalents thereof known to those skilled in the art, and so forth.

As used herein, the term “about” means plus or minus 10% of the numerical value of the number with which it is being used. Therefore, about 50% means in the range of 45%-55%.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A fiber reinforced sandwich composite panel comprising:
a sandwich composite panel comprising;
a top layer;
a bottom layer;
a core layer positioned between the top layer and the bottom layer; and,
a plurality of apertures, wherein each of the plurality of apertures pass through each layer of the composite panel; and
a continuous reinforcing yarn, wherein, the reinforcing yarn passes through each of the plurality of apertures;
wherein, the fiber reinforced sandwich composite panel has a thickness greater than about 30 mm, and
the volume fraction of the continuous reinforcing yarn in each of the plurality of apertures is greater than about 50%.

2. The fiber reinforced sandwich composite panel of claim 1, the volume fraction of the continuous reinforcing yarn in each of the plurality of apertures about 55%, about 60%, about 65%, about 70%, or any value or range between any two of these values.

3. The fiber reinforced sandwich composite panel of claim 1, wherein the fiber reinforced sandwich composite panel has a thickness of about 35 mm, about 40 mm, about 45 mm, about 50 mm, about 55 mm, about 60 mm, about 65 mm, about 70 mm, about 75 mm, about 80 mm, about 85 mm, about 90 mm, about 95 mm, about 100 mm, about 110 mm, about 120 mm, about 130 mm, about 140 mm, about 150 mm, about 160 mm, about 170 mm, about 180 mm, about 190 mm, about 200 mm, about 225 mm, about 250 mm, about 275 mm, about 300 mm, about 325 mm, about 350 mm, about 375 mm, about 400 mm, about 425 mm, about 450 mm, about 475 mm, about 500 mm, or any value or range between any two of these values.

4. The fiber reinforced sandwich composite panel of claim 1, wherein each of the top layer and the bottom layer have a thickness of about 0.1 mm, about 0.2 mm, about 0.25 mm, about 0.3 mm, about 0.4 mm, about 0.5 mm, about 0.6 mm, about 0.7 mm, about 0.8 mm, about 0.9 mm, about 1 mm, about 2 mm, about 3 mm, 4 mm, about 5 mm, about 6 mm, about 7 mm, about 8 mm, about 9 mm, about 10 mm, about 12 mm, about 14 mm, about 16 mm, about 18 mm, about 20 mm, about 25 mm, about 30 mm, about 35 mm, about 40 mm, about 45 mm, about 50 mm, or any value or range between any two of these values.

5. The fiber reinforced sandwich composite panel of claim 1, wherein each of the top layer and the bottom layer comprise polystyrene, polypropylene, carbon fiber, Kevlar fiber, aluminum, fiberglass, polyurethane, polyvinyl chloride, PET, polyethylene, nylon, or combinations thereof.

6. The fiber reinforced sandwich composite panel of claim 1, wherein the core layer has a thickness of about 25 mm, about 30 mm, about 35 mm, about 45 mm, about 50 mm, about 55 mm, about 60 mm, about 65 mm, about 70 mm, about 75 mm, about 80 mm, about 85 mm, 90 mm, about 95 mm, about 100 mm, about 110 mm, about 120 mm, about 130 mm, about 140 mm, about 150 mm, about 160 mm, about 170 mm, about 180 mm, about 190 mm, about 200 mm, about 225 mm, about 250 mm, about 275 mm, about 300 mm, about 325 mm, about 350 mm, about 375 mm, about 400 mm, about 425 mm, about 450 mm, about 475 mm, about 500 mm, or any value or range between any two of these values.

7. The fiber reinforced sandwich composite panel of claim 1, wherein the core layer comprises polystyrene, polyurethane, extruded polystyrene, polyisocyanurate, mineral wool, aluminum, polyvinyl chloride, fiberglass, polycarbonate, PET, polyethylene, carbon fiber, wood, or combinations thereof.

8. The fiber reinforced sandwich composite panel of claim 1, wherein the core layer has a structure, wherein the structure comprises a foam, a honeycomb, a lattice, composite tubes, or combinations thereof.

9. The fiber reinforced sandwich composite panel of claim 1, wherein each of the plurality of apertures has a diameter of about 5 mm, about 4 mm, about 3 mm, about 2 mm, about 1 mm, about 0.9 mm, about 0.8 mm, about 0.7 mm, about 0.6 mm, about 0.5 mm, or any value or range between any two of these values.

10. The fiber reinforced sandwich composite panel of claim 1, wherein the plurality of apertures is positioned in one of a periodic arrangement or a sporadic arrangement.

11. The fiber reinforced sandwich composite panel of claim 1, wherein the fiber reinforced sandwich composite panel comprises a concentration of apertures, wherein the concentration of apertures is 0.1 apertures/cm², 0.2 apertures/cm², 0.3 apertures/cm², 0.4 apertures/cm², 0.5 apertures/cm², 0.6 apertures/cm², 0.7 apertures/cm², 0.8 apertures/cm², 0.9 apertures/cm², 1 aperture/cm², 2 apertures/cm², 3 apertures/cm², 4 apertures/cm², 5 apertures/cm², or any value or range between any two of these values.

12. The fiber reinforced sandwich composite panel of claim 1, wherein the continuous reinforcing yarn comprises carbon fiber, glass fiber, Kevlar fiber, aramid fiber, polyester fiber, natural fibers, ultra-high molecular weight polyethylene fiber, or combinations thereof.

13. The fiber reinforced sandwich composite panel of claim 1, wherein the continuous reinforcing yarn has a tow value, wherein the tow value of the continuous reinforcing yarn is about 1K, about 2K, about 3K, about 4K, about 5K, about 6K, about 8K, about 10K, about 12K, about 15K, about 18K, about 21K, about 24K, about 28K, about 30K, about 32K, about 36K, about 40K, about 44K, about 48K, about 50K, or any value or range between any two of these values.

14. The fiber reinforced sandwich composite panel of claim 1 further comprising a continuous weft yarn;
wherein, the continuous reinforcing yarn comprises a plurality of stitches, and
the continuous weft yarn is interlocked with the continuous reinforcing yarn at each of the plurality of stitches.

15. The fiber reinforced sandwich composite panel of claim 14, wherein the continuous weft yarn comprises carbon fiber, glass fiber, Kevlar fiber, aramid fiber, ultra-high molecular weight polyethylene fiber, or combinations thereof.

16. The fiber reinforced sandwich composite panel of claim 1 further comprising a resin, wherein the resin is configured to transfer forces to the continuous reinforcing yarn and the resin comprises polyester, epoxy, vinyl ester, phenolic, polyurethane, ABS, polyethylene, polystyrene, polycarbonate, acrylic based resin, or combinations thereof.

17. A method of manufacturing a fiber reinforced sandwich composite panel comprising:
providing a composite panel having a thickness greater than about 30 mm comprising;
a top layer;
a bottom layer;
a core layer positioned between the top layer and the bottom layer; and,
a plurality of apertures, wherein each of the plurality of apertures passes through the core layer;
providing a continuous reinforcing yarn;
providing a continuous weft yarn;
creating a stitch at each of the plurality of apertures by threading the continuous reinforcing yarn through the top layer, one of the plurality of apertures, and the bottom layer; and
interlocking the continuous weft yarn with the continuous reinforcing yarn at each stitch.

18. The method of claim 17, wherein each of the plurality of apertures passes through the top layer and the bottom layer.

19. The method of claim 17, wherein the creating of each stitch comprises creating a stitch at one of the plurality of apertures adjacent to the previous stitch.

20. The method of claim 17, further comprising:
providing a resin and infusing the resin into the fiber reinforced sandwich composite panel;
degassing the resin; and
curing the fiber reinforced sandwich composite panel;
wherein infusing the resin comprises one of vacuum infusion, resin transfer molding, reaction injection molding, vacuum-assisted resin transfer molding, resin film infusion, or prepreg technology.
